(19) United States
(12) Patent Application Publication
(10) Pub. No.: US 2020/0192399 A1
(43) Pub. Date: Jun. 18, 2020

(54) METHOD FOR TRAVERSING A SUBAREA, METHOD FOR CLEANING, AND CLEANING ROBOT THEREOF

(71) Applicant: ShenZhen Silver Star Intelligent Technology Co., Ltd, Shenzhen (CN)

(72) Inventors: Peng LIU, Shenzhen (CN); Linghui SUI, Shenzhen (CN); Lirong YE, Shenzhen (CN)

(21) Appl. No.: 16/577,147

(22) Filed: Sep. 20, 2019

(30) Foreign Application Priority Data
Dec. 17, 2018 (CN) 201811542832.0

(51) Int. Cl. G05D 1/02; G05D 1/00; A47L 9/28; A47L 11/40

(52) U.S. Cl. CPC G05D 1/0268; G05D 1/0088; A47L 9/2826; A47L 2201/04; A47L 11/4061; A47L 9/2852; G05D 2201/0203; A47L 11/4011

(57) ABSTRACT

A method for traversing a subarea, a method for cleaning, and a cleaning robot thereof are provided. The method for traversing a subarea includes: gridding position information within the subarea to form a corresponding subarea grid map; searching for an edge grid in the subarea grid map, wherein the edge grid is a grid in close proximity to an edge of the subarea; searching for all continuous line segments in the subarea along a preset search direction, wherein the continuous line segment is a line segment that continuously extends from one edge grid along the search direction to another edge grid; matching the adjacent continuous line segments in sequence to form at least one connected region.

### CROSS REFERENCE TO RELATED APPLICATION

This application claims priority to Chinese Patent Application No. 201811542832.0 filed on Dec. 17, 2018, the content of which is incorporated herein by reference in its entirety.

### TECHNICAL FIELD

The present application relates to the field of automation and control technologies, and particularly to a method for traversing a subarea, a method for cleaning, and a cleaning robot thereof.

### BACKGROUND

When a robot is in an unknown environment, it usually achieves an environment exploration task by using SLAM (simultaneous localization and mapping), which allows the robot to gradually draw a complete map of the environment and enter each accessible corner or area without being subject to any obstacles.

Based on the map and the positioning information of the robot created by SLAM, the robot can perform a corresponding work task more efficiently. For many work tasks (such as cleaning tasks that the cleaning robot needs to perform), the robot needs to achieve the goal of traversing a certain area. That is, it is necessary to ensure that a route passed by the robot can completely cover the target area without missing any position.

In a practical application process, on the one hand, the unknown environment faced by the robot is always complicated and may even change (for example, when a situation such as obstacle movement etc. occurs), so the robot needs to provide a powerful ability to sense the environment (by using, for example, a large number and variety of sensors, a processor with more powerful performance, etc.). On the other hand, people always expect a robot having lower production cost, a smaller size, and other characteristics that ensure the practicality of the robot, which imposes a great limitation on the robot's ability to sense the environment.

Therefore, it is still a challenging and urgent problem to be solved that how to achieve the goal of traversing by the robot reliably and efficiently in these complex and varied work areas.

### SUMMARY

Embodiments of the present application provide a method for traversing a subarea, a method for cleaning, and a cleaning robot thereof, which aim to solve a technical problem that the robots in the prior art cannot achieve subarea traversal reliably and effectively.

In order to solve the above technical problem, the embodiments of the present application provide the following technical solution: a method for traversing a subarea. The method for traversing a subarea includes:

gridding position information within the subarea to form a corresponding subarea grid map;

searching for an edge grid in the subarea grid map, wherein the edge grid is a grid in close proximity to an edge of the subarea;

searching for all continuous line segments in the subarea along a preset search direction, wherein the continuous line segment is a line segment that continuously extends from one edge grid along the search direction to another edge grid;

matching the adjacent continuous line segments in sequence to form at least one connected region.

Alternatively, the method further includes: acquiring real-time position information and a global grid map; determining at least one enclosed subarea in the global grid map.

Alternatively, each of the grids in the global grid map is provided with a corresponding attribute, and the attributes comprises a boundary grid of the subarea, a passable grid of the subarea, a barrier grid of the subarea, and an unknown grid of the subarea.

Alternatively, the step of determining at least one enclosed subarea in the global grid map specifically includes:

determining one or more boundary grids of the subarea according to a preset partition planning; determining whether a position difference between adjacent two of the boundary grids of the subarea exceeds a preset resolution; inserting one or more boundary grids of the subarea between the adjacent boundary grids of the subarea to form the enclosed subarea, if the position difference between the adjacent two of the boundary grids of the subarea exceeds the preset resolution.

Alternatively, the step of inserting one or more boundary grids of the subarea between the adjacent boundary grids of the subarea specifically includes: supplementing and inserting a corresponding number of boundary grids of the subarea based on row difference and column difference between a current position and a previous position.

Alternatively, the position information is represented by a ternary array (x_f, y_f, th_f), and the grid in the subarea grid map is represented by a binary array (x_i, y_i), where x_f is an abscissa value, y_f is an ordinate value, and th_f is a yaw angle, x_i is a column in which the grid is located, and y_i is a row in which the grid is located.

Alternatively, the step of gridding position information within the subarea to form a subarea grid map specifically includes:

converting the position information with floating point values into grid positions with integer values according to conversion formulas as shown below:

origin_x_i=w−int(origin x_f/res+0.5);

origin_y_i=h−int(origin_y_f/res+0.5);

x_i=origin x_i−(x_f+0.5)/res;

y_i=origin_y_i−(y_f+0.5)/res;

where w is a total number of the rows of the global grid map, h is a total number of the columns of the global grid map, (origin_x_f, origin_y_f) is initial position information, (origin_x_i, origin_y_i) is an initial grid corresponding to the initial position information, int is a downward bracket function, and res is resolution.

Alternatively, the step of searching for an edge grid in the subarea grid map specifically includes:

determining a maximum value and a minimum value of x_i in the region enclosed by the subarea, where y is the column in which the grid is located;

searching for a maximum value and a minimum value of y_i in the subarea line by line within a range of values of x_i, wherein the edge grids are a grid when y_i takes the maximum value and a grid when y_i takes the minimum value, and y_i is the row in which the grid is located.

Alternatively, the step of searching for all continuous line segments in the subarea along a preset search direction includes:

searching for the continuous line segments located in the subarea along a column direction of the subarea grid map by taking one grid as step size;

determining whether the length of each of the continuous line segments is greater than a preset resolution threshold; removing the continuous line segment if the length of the continuous line segment is not greater than the preset resolution threshold.

Alternatively, the step of matching the adjacent continuous line segments in sequence to form at least one connected region specifically includes:

determining, according to a preset matching order, whether the continuous line segments located in adjacent two columns are connected until all the continuous line segments are traversed; forming the connected region by the one or more continuous line segments that are connected to each other among different columns.

In order to solve the above technical problem, the embodiments of the present application further provide the following technical solution: a method for cleaning. The method for cleaning includes: forming at least one connected region by applying the above-mentioned method for traversing a subarea; determining the connected region as a cleanable region, and cleaning for the cleanable region in sequence.

In order to solve the above technical problem, the embodiments of the present application further provide the following technical solution: a cleaning robot, including a traveling mechanism, an environment sensor, and a cleaning mechanism. Among them, the cleaning robot applies the above-mentioned method for cleaning based on the environment sensor, and the cleaning mechanism is configured to clean for at least one subarea when the traveling mechanism is controlled to move in the connected cleanable region.

Compared with the prior art, the area division method provided by the embodiments of the present application provides an efficient and reliable method for traversing a subarea. The method uses a gridding manner, and is based on the positioning information and the grid map provided by the SLAM module, so it can quickly find out all the connected regions in a specific range of area, such that the equipment such as the cleaning robot etc. can well achieve the task of traversing a single subarea.

### DESCRIPTION OF THE DRAWINGS

One or more embodiments are exemplarily illustrated through the figures in their corresponding accompanying drawings, and these exemplary illustrations do not constitute a limitation on the embodiments. Elements with the same reference sign in the accompanying drawings are represented as similar elements, and the figures in the accompanying drawings do not constitute a proportional limitation unless otherwise stated.

FIG. 1 is a schematic diagram of an application environment according to an embodiment of the present application.

FIG. 2 is a block diagram showing functions of a cleaning robot according to an embodiment of the present application.

FIG. 3 is a block diagram showing hardware of a control chip according to an embodiment of the present application.

FIG. 4 is a schematic diagram of a global grid map according to an embodiment of the present application.

FIG. 5 is a flowchart of a method for traversing a subarea according to an embodiment of the present application.

FIG. 6 is a flowchart of a method for traversing a subarea according to another embodiment of the present application.

### DETAILED EMBODIMENTS

In order to facilitate the understanding of the present application, the present application will be described in more detail below with reference to the accompanying drawings and specific embodiments. It should be noted that, when an element is referred to as “being fixed to” another element, the element may be directly on said another element, or one or more intermediate elements may be present therebetween. When an element is referred to as “being connected to” another element, the element may be directly connected to said another element, or one or more intermediate elements may be present therebetween. The orientation or position relationship indicated by the terms used in the specification, such as “upper”, “lower”, “inner”, “outer”, “bottom” and the like, is based on the orientation or position relationship as shown in the accompanying drawings, which is intended to facilitate description of the present application and simplification of the description, but not to be construed as indicating or implying that the indicated device or element has to be provided with a specific orientation or constructed or operated in a specific orientation, therefore the orientation or position relationship cannot be understood as limitation on the present application. Moreover, the terms “first”, “second”, “third”, and the like are used for descriptive purposes only, and are not to be construed as indicating or implying relative importance.

All the technical and scientific terms used in the specification have the same meaning as commonly understood by those skilled in the art to which the present application pertains, unless otherwise defined. The terms used in the specification of the present application is for the purpose of describing particular embodiments and is not intended to limit the present application. The term “and/or” used in the specification includes any and all combinations of one or more of the associated listed items.

Further, the technical features involved in different embodiments of the present application described below may be combined with each other as long as they do not constitute a conflict with each other.

SLAM (simultaneous localization and mapping) is a technique for solving problems in unknown environment exploration. When a robot is placed in an unknown environment, it can continuously expand and construct a map of the unknown environment and determine positioning coordinates of the robot in the map through SLAM, so as to achieve orderly control of the robot's work and movement.

“Subarea” is a closed area with a specific area formed by dividing the map according to a specific area division strategy when the robot performs work tasks. The robot can perform work tasks in a unit of subarea to improve work efficiency. For example, after the robot in a certain area completes a work task for that area, the area can be marked as a completed area to avoid repeatedly performing the work task.

FIG. 1 is a schematic diagram of an application environment of a method for traversing a subarea according to an embodiment of the present application. In FIG. 1, that a cleaning robot performs cleaning work is taken as an example for illustration.

Of course, the method for traversing a subarea according to the embodiments of the present application may also be applied by other different robots or applied to other different work tasks by those skilled in the art. Moreover, in order to be applied by other different robots or applied to other different work tasks, all adjustments, combinations, or simple variations made to the technical solutions of the embodiments of the present application are alternatives that are easily envisaged by those skilled in the art and fall within the protection scope of the present application.

As shown in FIG. 1, the application environment includes: a cleaning robot 10, an environment 20 to be cleaned, and an obstacle W30. The environment 20 to be cleaned is an unknown environment with regard to the cleaning robot 10, and the cleaning robot 10 needs to ensure that the entire environment to be cleaned can be cleaned up without missing anywhere on the basis of environment exploration through SLAM and area division.

The environment 20 to be cleaned is a space having a specific area, such as a certain room or living room in the home. A corresponding global coordinate system can be constructed in the space with a certain coordinate origin. In the process of exploring the environment, a geographical position of the cleaning robot within the environment 20 may be represented by a corresponding positioning coordinate of the cleaning robot.

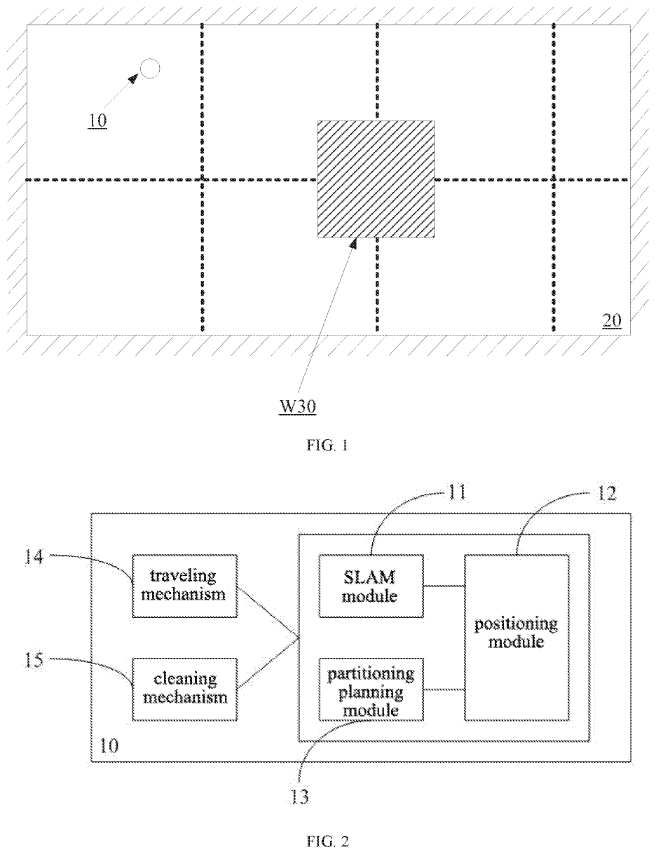

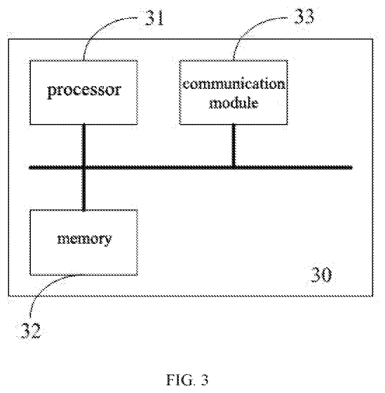

As shown in FIG. 2, in order to perform the cleaning work, the cleaning robot 10 may include at least several function modules as follows: a SLAM module 11, a positioning module 12, a partition planning module 13, a traveling mechanism 14, and a cleaning mechanism 15.

The SLAM module 11 is a function module configured to execute SLAM to realize identification of an unknown environment. Through the SLAM module, the cleaning robot may continuously explore by a range with a determined size, and create a map of the entire environment to be cleaned during walking.

The positioning module 12 is a function module configured to provide current position information of the cleaning robot in real time in any manner. The positioning module 12 may be equipped with one or more sensors according to actual needs, so as to give the robot an ability to sense the external environment, for example, a sensor such as laser sensor and a RGBD camera, etc. configured to collect data related with the external environment.

In some embodiments, the real-time position information of the cleaning robot may be represented by a following ternary array (x_f, y_f, th_f). Where, x_f is an abscissa value, y_f is an ordinate value, and th_f is a yaw angle, and all three parameters are floating-point values.

The partition planning module 13 is a function module configured to perform the above-described area division. The partition planning module may divide one or more closed areas on the map by using any partitioning logic. In an actual area division process, the partition planning module 13 acquires the real-time position information of the cleaning robot from the positioning module 12 to complete the work task of the area division, and creates or divides an area with a specific area.

The traveling mechanism 14 is a structural device that provides the cleaning robot with a moving ability to drive the cleaning robot to move along a set route. The traveling mechanism may be implemented by any type of mobile device, such as a roller, a crawler, or the like.

The cleaning mechanism 15 is one or more devices configured to implement a ground cleaning task, which includes, but is not limited to, a water storage tank, a mop, a V-roller, a dust box, and the like. The cleaning mechanism may have a detachable characteristic, and may perform cleaning work for the area with a specific area by using a different cleaning mechanism with regard to a different cleaning work task.

It should be noted that, the SLAM module 11, the positioning module 12 and the partition planning module 13 provided by the embodiment of the present application may be executed by a control system inside the cleaning robot. The control system may realize or implement the functions of the above-described function modules in a form of electronic hardware, computer software programs, or a combination thereof.

In order to clearly illustrate the interchangeability of hardware and software, the composition and steps of these function modules are generally described in terms of functionality in the embodiments of the present application. Whether these functions are performed in the form of hardware or software depends on a specific application and design constraint of the technical solution. Those skilled in the art may implement the described functions by using a different method for each particular application, but such implementation should not be considered as going beyond the scope of the present application.

FIG. 3 is a block diagram of the structure of the control system according to an embodiment of the present application. As shown in FIG. 3, the control system may include a processor 31, a memory 32, and a communication module 33. In FIG. 3, a bus connection is taken as an example to establish a communication connection between any two of the processor 31, the memory 32, and the communication module 33.

The processor 31 can be any type of single or multi-threaded processor. The processor 31 may have one or more processing cores as a control hub for acquiring data, performing a logical operation function, and issuing an operation processing result and the like.

The memory 32 is a non-volatile computer readable storage medium, such as at least one of a magnetic disk storage device, a flash memory device, and a distributed storage device remotely disposed with respect to processor 31, or other non-volatile solid storage device, or the like. The memory 32 has a program memory area for storing a non-volatile software program, a non-volatile computer executable program, and a module.

These computer executable programs and function modules may be invoked by the processor 31 to cause the processor 31 to perform the one or more method steps. The memory 32 may further have a data memory area for storing the operation processing result issued and output by the processor 31.

The communication module 33 is a hardware module configured to establish a communication connection between a control chip and an external function module. The communication module 33 may be selected as a corresponding type of wireless or wired communication module according to actual needs, such as a WiFi module, a Bluetooth module, or an input/output interface.

Based on the communication module 33, the control chip 30 may collect a user instruction and present a corresponding interactive interface to the user. For example, the control chip 30 may establish a connection with the user's smart mobile terminal through the WiFi module, and collect the user instruction or display a current working state of the cleaning robot to the user through an APP or a webpage.

In some embodiments, the exploration of the SLAM module 11 and the area division of the partition planning module 13 may occur simultaneously. After the partition planning module 13 creates a subarea, the cleaning robot 10 may require a global grid map at this time from the SLAM module 11.

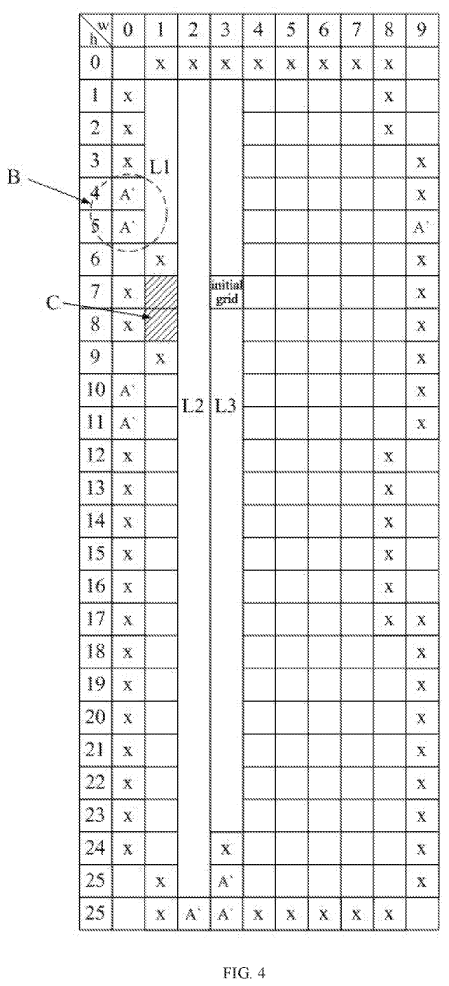

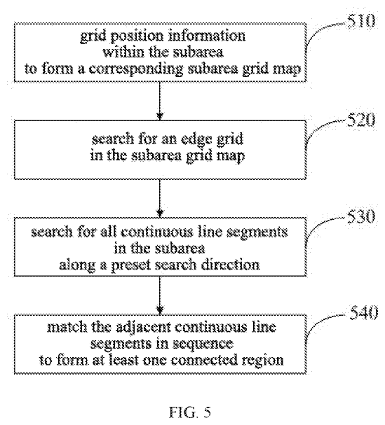

The global grid map refers to a map in which the entire global map is divided into a plurality of grids at a set resolution. FIG. 4 is a schematic diagram of the global grid map according to an embodiment of the present application.

As shown in FIG. 4, the entire map consists of grids of w columns and h rows. For any grid in the global grid map, it may be defined by a binary array (x_i, i), where x_i is the column in which the grid is located (also known as the column index), and y_i is the row in which the grid is located (also known as the row index).

The area of each of the grids is determined by the set resolution (the resolution is positively correlated with the area of each of the grids). The resolution may be set by a technician according to needs of an actual situation, for example, the resolution is set to 0.05 in a unit of meter.

In addition, in the global grid map, each of the grids is provided with a corresponding attribute or identifier based on the result of the environment exploration. For example, the grids may include several kinds of grids of the subarea, including a boundary grid, a passable grid, a barrier grid, and an unknown grid, which are respectively used for indicating several attributes that the grid belongs to a boundary of the subarea, an area that the cleaning robot can pass through, an area that the cleaning robot cannot pass through, and an unknown situation.

In FIG. 4, w takes 10 values, which is respectively represented by column numbers 0-9, and h takes 18 values, which is respectively represented by row numbers 0-17. In addition, according to the result of the area division, the boundary grid of the subarea passed by a boundary forming the closed subarea is represented by x.

In some embodiments, the difference in position between two adjacent boundary grids of the subarea may exceed a preset resolution (as shown in portion B of FIG. 4). This will make the boundaries of the subarea discontinuous and cannot form a closed subarea.

Thus, a suitable fill and insertion method may be adopted to actively insert one or more boundary grids A of the subarea in the portion B, so as to form a continuous boundary of the subarea, thereby forming the closed subarea. For example, based on row difference and column difference between the current position and the previous position of the cleaning robot, a corresponding number of boundary grids A of the subarea may be supplemented and inserted to ensure continuity of the boundaries of the subarea on the grid map.

For simplicity of description, in the embodiment of the present application, a portion corresponding to the closed area surrounded by the plurality of continuous boundary grids x of the subarea is referred to as a “subarea grid map”. The method for traversing a single subarea according to an embodiment of the present application is described in detail below by taking the subarea grid map as shown in FIG. 4 as an example.

As shown in FIG. 5, the method for traversing may include the following steps.

At 510, grid position information within the subarea to form the corresponding subarea grid map.

gridding refers to a process of converting the position information provided by the positioning module 12 into the corresponding grids in the grid map. After gridding, each of the position information within the subarea may be grouped into a corresponding grid, and the entire subarea may be divided into several grids as shown in FIG. 4.

Those skilled in the art will appreciate that, the gridding is a conversion process that the floating point values (position information) are converted into integer values (the rows and columns in which the grid is located). Specifically, the conversion from the floating point values into the integer values may be realized by the following conversion formula.

The position information of the floating point values is converted into grid positions of the integer values according to the conversion formulas (1) to (4) as shown below:

origin_x_i=w−int(origin_x_f/res+0.5) (1)

origin_y_i=h−int(origin_y_f/res+0.5) (2)

x_i=origin_x_i−(x_f+0.5)/res (3)

y_i=origin_y_i−(y_f+0.5)/res (4)

Where, w is a total number of the rows of the global grid map, h is a total number of the columns of the global grid map, (origin_x_f, origin_y_f) is initial position information, (origin_x_i, origin_y_i) is an initial grid corresponding to the initial position information, int is a downward bracket function, and res is the resolution.

The role of the constant value of 0.5 in the formula is to achieve an effect of “rounding off” for the fractional parts of the floating-point values during the conversion toward integer values. The constant value may be adjusted or set by those skilled in the art according to actual needs.

In addition, in the conversion process of formulas (3) and (4), the system of the cleaning robot may be forced to convert the values into integer values to determine the rows and columns of the grids according to some preset rounding principles.

At 520, search for an edge grid in the subarea grid map.

The edge grid is a grid that is in close proximity to the edge of the subarea, that is, a grid adjacent to the boundary grid of the subarea in the subarea grid map.

Since the positions of these edge grids may represent the innermost portion of the subarea, they are positions of some extreme values. Therefore, they are very important identifiers that need to be used in traversing the subarea.

At 530, search for all continuous line segments in the subarea along a preset search direction. The continuous line segment is a line segment that continuously extends from one edge grid in the search direction to another edge grid.

Since the continuous line segments have the same width as the grids, and all starting points based on the continuous line segments are edge grids, and the starting points of different continuous line segments are different, therefore the continuous line segments with a certain width will include all the edge grids after spliced, thereby covering the entire subarea.

The preset search direction may be set by the technician according to the needs or experience of an actual situation. The preset search direction represents the order for searching for the continuous line segments within the subarea and the direction in which the continuous line segments extend. For example, the search direction may be a direction along the column of the subarea (i.e., the vertical direction) or a direction along the row of the subarea (i.e., the horizontal direction).

In some embodiments, excessively short continuous line segments generally represent some very small edge changes, such as the continuous line segment C as shown in FIG. 4. These continuous line segments usually do not have much impact on the task object of traversing.

In order to improve the cleaning efficiency of the cleaning robot, a filtering step may be added during the process of searching for the continuous line segments to determine whether the length of each of the continuous line segments is greater than a preset resolution threshold. The continuous line segment is determined to be a continuous line segment if the length of the continuous line segment is greater than the preset resolution threshold, otherwise the continuous line segment is removed.

The preset resolution threshold is an empirical value, which may be determined by a person skilled in the art according to an actual condition or through an experiment. Of course, in some embodiments, the preset resolution threshold may also be represented by a suitable model to implement adaptive adjustment.

At 540, match the adjacent continuous line segments in sequence to form at least one connected region.

As shown in FIG. 4, the region enclosed within the subarea is composed of a plurality of parallel continuous line segments. In the process of traversing the subarea, the matching process among the plurality of the continuous line segments may be iteratively performed to determine the interrelationship among all the continuous line segments.

Specifically, according to a result of the actual environmental exploration, the interrelationship between any two adjacent continuous line segments may be mutual connectivity (i.e., there is a passable grid for connection between the two line segments, which allows the cleaning robot to pass through smoothly) or non-connectivity.

The connected region is a region composed of a plurality of continuous line segments that communicate with each other. For example, the first continuous line segment L1 located at the second column and the third column L2 as shown in FIG. 4 are in communication with each other, and the fourth column L3 and the third column L2 are in communication with each other, such that the three continuous line segments may form one connected region.

The connected region, formed by the method for traversing a subarea provided by the embodiments of the present application, can guide the movement of the cleaning robot, so that the cleaning robot can traverse the entire subarea, and ensure that all positions in the subarea can be cleaned up.

The method for traversing a subarea provided by the embodiments of the present application is sequentially applied to each of the subareas in the global map, and the connected region in the subarea is determined as a cleanable region, and accordingly, the cleaning robot is guided to move and clean in the cleanable region, such that the cleaning work for the entire environment 20 to be cleaned may be finally completed.

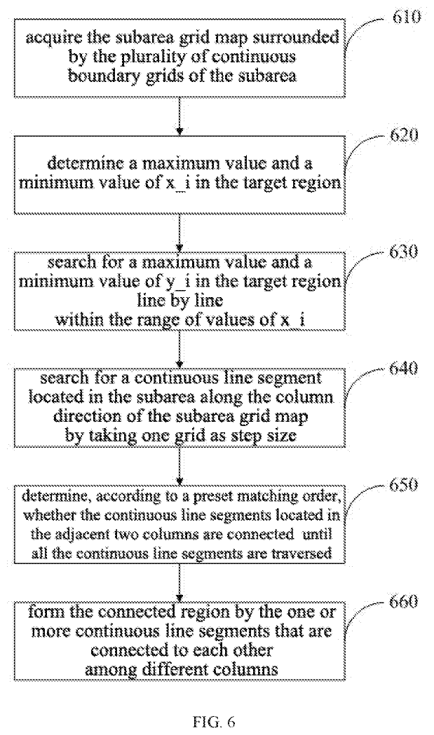

FIG. 6 is a flowchart of a specific implementation of traversing a single subarea by the cleaning robot 10 according to an embodiment of the present application. As shown in FIG. 6, the implementation process may include the following steps.

At 610, acquire the subarea grid map surrounded by the plurality of continuous boundary grids of the subarea. On this basis, a target region required to be traversed and cleaned is determined by the cleaning robot (i.e., the portion enclosed inside the subarea).

At 620, determine a maximum value and a minimum value of x_i in the target region.

When the cleaning and traversal are done according to a top-to-bottom mode, the maximum value of x_i represents the largest column (i.e., the largest number of the columns) in the target region, and the minimum value of x_i represents the smallest column in the target region. On this basis, the range of the target region in the width may be determined according to the maximum value and the minimum value of the values of x_i.

At 630, search for a maximum value and a minimum value of y_i. in the target region line by line within the range of values of x_i.

“Searching line by line” is to determine the maximum value and the minimum value of y_i on each of the lines of the target region. The minimum value and the maximum value of y_i respectively represent the grids at the farthest ends on this line (i.e. the edge grids).

When the search starts from the smallest column, let x_i=x_i+1 to implement the search line by line after completing search for one line. If the search starts from the largest column, let x_i=x_i−1 to implement the search line by line after completing search for one line.

At 640, search for a continuous line segment located in the subarea along the column direction of the subarea grid map by taking one grid as step size.

As shown in FIG. 4, the column direction of the subarea grid map refers to the vertical direction. That is, the grids of the same continuous line segment have the same values of x_i.

At 650, determine, according to a preset matching order, whether the continuous line segments located in the adjacent two columns are connected until all the continuous line segments are traversed.

The matching order may start with the smallest column, or the largest column until all the continuous line segments are matched.

At 660, form the connected region by the one or more continuous line segments that are connected to each other among different columns.

From the above, the method for traversing a subarea provided by the embodiments of the present application is based on the positioning information and the grid map provided by the SLAM module, and can quickly look up the connected region in a single subarea, so that the cleaning robot etc. can complete well the task object of traversing a subarea to ensure that all the area within the subarea can be cleaned.

Finally, it should be noted that, the above embodiments are only used to illustrate the technical solutions of the present application, and are not limitation thereto. Under the idea of the present application, the technical features in the above embodiments or different embodiments may also be combined, and the steps may be carried out in any order, and there are many other variations of the various aspects of the present application as described above, which are not provided in detail for the sake of brevity. Although the present application has been described in detail with reference to the foregoing embodiments, it should be understood by those skilled in the art that the technical solutions described in the foregoing embodiments may still be modified, or some of the technical features may be equivalently substituted, and these modifications or substitutions do not deviate the nature of corresponding technical solutions from the scope of the technical solutions of the various embodiments of the present application.

What is claimed is:

1. A method for traversing a subarea, comprising:
gridding position information within the subarea to form a corresponding subarea grid map;
searching for an edge grid in the subarea grid map, wherein the edge grid is a grid in close proximity to an edge of the subarea;
searching for all continuous line segments in the subarea along a preset search direction, wherein the continuous line segment is a line segment that continuously extends from one edge grid along the search direction to another edge grid;
matching the adjacent continuous line segments in sequence to form at least one connected region.

2. The method according to claim 1, wherein the method further comprises:
acquiring real-time position information and a global grid map;
determining at least one enclosed subarea in the global grid map.

3. The method according to claim 2, wherein each of the grids in the global grid map is provided with a corresponding attribute, and the attributes comprises a boundary grid of the subarea, a passable grid of the subarea, a barrier grid of the subarea, and an unknown grid of the subarea.

4. The method according to claim 3, wherein the step of determining at least one enclosed subarea in the global grid map specifically comprises:
determining one or more boundary grids of the subarea according to a preset partition planning;
determining whether a position difference between adjacent two of the boundary grids of the subarea exceeds a preset resolution;
inserting one or more boundary grids of the subarea between the adjacent boundary grids of the subarea to form the enclosed subarea, if the position difference between the adjacent two of the boundary grids of the subarea exceeds the preset resolution.

5. The method according to claim 4, wherein the step of inserting one or more boundary grids of the subarea between the adjacent boundary grids of the subarea specifically comprises:
supplementing and inserting a corresponding number of boundary grids of the subarea based on row difference and column difference between a current position and a previous position.

6. The method according to claim 2, wherein the position information is represented by a ternary array (x_f, y_f, th_f), and the grid in the subarea grid map is represented by a binary array (x_i, y_i),
where x_f is an abscissa value, y_f is an ordinate value, and th_f is a yaw angle, x_i is a column in which the grid is located, and y_i is a row in which the grid is located.

7. The method according to claim 6, wherein the step of gridding position information within the subarea to form a subarea grid map specifically comprises:
converting the position information with floating point values into grid positions with integer values according to conversion formulas as shown below:
origin_x_i=w−int(origin_x_f/res+0.5);
origin_y_i=h−int(origin_y_f/res+0.5);
x_i=origin_x_i−(x_f+0.5)/res;
y_i=origin_y_i−(y_f+0.5)/res;
where w is a total number of the rows of the global grid map, h is a total number of the columns of the global grid map, (origin_x_f, origin_y_f) is initial position information, (origin_x_i, origin_y_i) is an initial grid corresponding to the initial position information, int is a downward bracket function, and res is resolution.

8. The method according to claim 6, wherein the step of searching for an edge grid in the subarea grid map specifically comprises:
determining a maximum value and a minimum value of x_i in the region enclosed by the subarea, where y is the column in which the grid is located;
searching for a maximum value and a minimum value of y_i in the subarea line by line within a range of values of x_i, wherein the edge grids are a grid when y_i takes the maximum value and a grid when y_i takes the minimum value, and y_i is the row in which the grid is located.

9. The method according to claim 1, wherein the step of searching for all continuous line segments in the subarea along a preset search direction comprises:
searching for the continuous line segments located in the subarea along a column direction of the subarea grid map by taking one grid as step size;
determining whether the length of each of the continuous line segments is greater than a preset resolution threshold;
removing the continuous line segment if the length of the continuous line segment is not greater than the preset resolution threshold.

10. The method according to claim 9, wherein the step of matching the adjacent continuous line segments in sequence to form at least one connected region specifically comprises:
determining, according to a preset matching order, whether the continuous line segments located in adjacent two columns are connected until all the continuous line segments are traversed;
forming the connected region by the one or more continuous line segments that are connected to each other among different columns.

11. A method for cleaning, comprising:
forming at least one connected region by applying the method for traversing a subarea according to claim 1;
determining the connected region as a cleanable region, and cleaning for the cleanable region in sequence.

12. A cleaning robot, comprising a traveling mechanism, an environment sensor, cleaning mechanism, and a control system, wherein the environment sensor is configured to sense external environment, and to acquire current position information of the cleaning robot in real time according to collected data related with the external environment, wherein the control system is configured to:
grid position information within a subarea to form a corresponding subarea grid map;
search for an edge grid in the subarea grid map, wherein the edge grid is a grid in close proximity to an edge of the subarea;
search for all continuous line segments in the subarea along a preset search direction, wherein the continuous line segment is a line segment that continuously extends from one edge grid along the search direction to another edge grid;
match the adjacent continuous line segments in sequence to form at least one connected region;
wherein the cleaning mechanism is configured to clean for the at least one region when the traveling mechanism drives the cleaning robot to move in the connected region.

13. The cleaning robot according to claim 12, wherein the step of forming the at least one connected region further comprises:
acquiring real-time position information and a global grid map;
determining at least one enclosed subarea in the global grid map.

14. The cleaning robot according to claim 13, wherein each of the grids in the global grid map is provided with a corresponding attribute, and the attributes comprises a boundary grid of the subarea, a passable grid of the subarea, a barrier grid of the subarea, and an unknown grid of the subarea.

15. The cleaning robot according to claim 14, wherein the step of determining at least one enclosed subarea in the global grid map specifically comprises:
determining one or more boundary grids of the subarea according to a preset partition planning;
determining whether a position difference between adjacent two of the boundary grids of the subarea exceeds a preset resolution;
inserting one or more boundary grids of the subarea between the adjacent boundary grids of the subarea to form the enclosed subarea, if the position difference between the adjacent two of the boundary grids of the subarea exceeds the preset resolution.

16. The cleaning robot according to claim 15, wherein the step of inserting one or more boundary grids of the subarea between the adjacent boundary grids of the subarea comprises:
supplementing and inserting a corresponding number of boundary grids of the subarea based on row difference and column difference between a current position and a previous position.

17. The cleaning robot according to claim 13, wherein the position information is represented by a ternary array (x_f, y_f, th_f), and the grid in the subarea grid map is represented by a binary array (x_i, y_i),
where x_f is an abscissa value, y_f is an ordinate value, and th_f is a yaw angle, x_i is a column in which the grid is located, and y_i is a row in which the grid is located.

18. The cleaning robot according to claim 17, wherein the step of gridding position information within the subarea to form a subarea grid map specifically comprises:
converting the position information with floating point values into grid positions with integer values according to conversion formulas as shown below:
origin_x_i=w−int(origin_x_f/res+0.5);
origin_y_i=h−int(origin_y_f/res+0.5);
x_i=origin_x_i−(x_f+0.5)/res;
y_i=origin_y_i−(y_f+0.5)/res;
where w is a total number of the rows of the global grid map, h is a total number of the columns of the global grid map, (origin_x_f, origin_y_f) is initial position information, (origin_x_i, origin_y_i) is an initial grid corresponding to the initial position information, int is a downward bracket function, and res is resolution.

19. The cleaning robot according to claim 17, wherein the step of searching for an edge grid in the subarea grid map specifically comprises:
determining a maximum value and a minimum value of x_i in the region enclosed by the subarea, where x_i is the column in which the grid is located;
searching for a maximum value and a minimum value of y_i in the subarea line by line within a range of values of x_i, wherein the edge grids are a grid when y_i takes the maximum value and a grid when y_i takes the minimum value, and y_i is the row in which the grid is located.

20. The cleaning robot according to claim 12, wherein the step of searching for all continuous line segments in the subarea along a preset search direction comprises:
searching for the continuous line segments located in the subarea along a column direction of the subarea grid map by taking one grid as step size;
determining whether the length of each of the continuous line segments is greater than a preset resolution threshold;
removing the continuous line segment if the length of the continuous line segment is not greater than the preset resolution threshold.
